(19) United States
(12) Patent Application Publication
(10) Pub. No.: US 2026/0287411 A1
(43) Pub. Date: Sep. 24, 2026

(54) FILL LEVEL MEASURING DEVICE FOR PROCESS AUTOMATION IN AN INDUSTRIAL OR PRIVATE SETTING

(71) Applicant: VEGA GRIESHABER KG, Wolfach (DE)

(72) Inventors: Clemens HENGSTLER, Haslach (DE); Matthias SCHMIDT, Schonach (DE)

(73) Assignee: VEGA GRIESHABER KG, Wolfach (DE)

(21) Appl. No.: 19/478,375

(22) PCT Filed: Apr. 11, 2024
(86) PCT No.: PCT/EP2024/059904

§ 371 Date: Oct. 24, 2025

(30) Foreign Application Priority Data
Apr. 27, 2023 (DE) 10 2023 203 927.3

(51) Int. Cl. G01F 23/284

(52) U.S. Cl. CPC G01F 23/284

(57) ABSTRACT

A level measuring device configured for process automation in industrial or private environments is provided, including: a measurement signal generation and control circuit configured to generate a first measurement signal for performing a signal propagation time measurement and to generate a second measurement signal for performing a measurement signal attenuation measurement; and an antenna configured to radiate the first and the second measurement signals in a direction of a fill level surface and to receive the first measurement signal reflected at the fill level surface or the second measurement signal reflected at the fill level surface for calculating the fill level, the measurement signal generation and control circuit being further configured to switch between generating the first measurement signal and generating the second measurement signal.

### REFERENCE TO RELATED APPLICATIONS

The present application claims the priority of German patent application No. 10 2023 203 927.3, filed on Apr. 27, 2023, which is incorporated in its entirety by reference into the present document.

### FIELD OF THE INVENTION

The invention relates to level measurement technology. In particular, the present disclosure relates to a level measuring device that is configured for process automation in industrial or private environments.

### TECHNICAL BACKGROUND

In level measurement technology in industrial or private environments, level measuring devices are used which emit measurement signals towards the surface of the filling material and receive the signals reflected from it. From this, an echo curve can be calculated in which the level echo can be identified. The level can then be calculated from this. In this context, one also speaks of time-of-flight measurement methods or ToF methods.

The measurement signals can be emitted in the form of signal pulses (known as the pulse method) or in the form of frequency-modulated continuous wave signals (known as the FMCW method).

However, it has been found that under certain circumstances these measurement methods provide inaccurate or no level values, for example because foam has formed on the surface of the filling material or the measurement signal is reflected by container fittings and this interference echo is incorrectly classified as a level echo.

### SUMMARY

Against this background, it is an object of the present disclosure to provide a level measuring device that delivers level measurement results with increased reliability.

This object is solved by the features of the independent patent claims. Further details of the invention are provided in the subclaims and the following description of embodiments.

A first aspect of the present disclosure relates to a level measuring device that is configured for process automation in industrial or private environments. It has a measurement signal generation and control circuit that is configured to generate a first measurement signal for performing a signal propagation time measurement and a second measurement signal for performing a measurement signal attenuation measurement.

An antenna is provided which is configured to radiate the first measurement signal and/or the second measurement signal in the direction of the surface of the filling material and to receive the first and/or second measurement signal reflected at the surface of the filling material in order to calculate the fill level.

The measurement signal generation and control circuit is specifically configured to switch between generating the first measurement signal and generating the second measurement signal.

This makes it possible to perform a signal propagation time measurement and a measurement signal attenuation measurement in succession. According to an embodiment, these two different measurements are to be performed in succession. According to a further embodiment, these two measurements are to be performed simultaneously.

The measurement with the second measurement signal can be used for overfill detection, i.e., when the antenna of the level measuring device is immersed in the filling material or completely covered by it. Additional sensors, such as capacitive sensors, are not required for flood detection of the measuring device housing. The present disclosure provides, in particular, a level radar sensor that can reliably and safely detect when it is immersed in or even flooded by the filling material. To this end, the level measuring device not only operates according to the ToF method (pulse or FMCW), but also switches to a continuous wave signal in a time-controlled manner or alternately depending on the signal in order to then measure the attenuation.

The term “process automation in an industrial environment” can be understood as a subfield of technology that includes measures for operating machines and systems without human intervention. One goal of process automation is to automate the interaction of individual components of a plant in the chemical, food, pharmaceutical, petroleum, paper, cement, shipping, or mining industries. A wide range of sensors can be used for this purpose, which are specially adapted to the specific requirements of the process industry, such as mechanical stability, insensitivity to contamination, extreme temperatures, and extreme pressures. The measured values from these sensors are usually transmitted to a control room, where process parameters such as fill level, limit level, flow, pressure, or density can be monitored and settings for the entire plant can be changed manually or automatically.

One sub-area of process automation in the industrial environment concerns the logistics automation of plants and the logistics automation of supply chains. With the help of distance and angle sensors, processes within or outside a building or within a single logistics facility are automated in the field of logistics automation. Typical applications include logistics automation systems for baggage and cargo handling at airports, traffic monitoring (toll systems), retail, parcel distribution, and building security (access control). What the examples listed above have in common is that presence detection in combination with accurate measurement of the size and position of an object is required by the respective application. For this purpose, sensors based on optical measurement methods using lasers, LEDs, 2D cameras, or 3D cameras that measure distances using the time-of-flight (ToF) principle can be used.

Another subfield of process automation in the industrial environment concerns factory/production automation. Applications for this can be found in a wide variety of industries, such as automotive manufacturing, food production, the pharmaceutical industry, or in the packaging sector in general. The aim of factory automation is to automate the manufacture of goods using machines, production lines, and/or robots, i.e., to run processes without human intervention. The sensors used and the specific requirements in terms of measurement accuracy when detecting the position and size of an object are comparable to those in the previous example of logistics automation.

The terms used in the claims should be interpreted to give them the broadest reasonable interpretation consistent with the foregoing description. For example, the use of the article “a” or “the” in introducing an element should not be interpreted to exclude a plurality of elements. Similarly, the mention of “or” should be interpreted as including a plurality of elements, so that the mention of “A or B” does not exclude “A and B” unless it is clear from the context or the preceding description that only one of A and B is meant. Furthermore, the phrase “at least one of A, B, and C” should be understood as one or more elements from a group of elements consisting of A, B, and C, and should not be interpreted as requiring at least one of each of the listed elements A, B, and C, regardless of whether A, B, and C are connected as categories or in any other way. In addition, the mention of “A, B, and/or C” or “at least one of A, B, or C” should be interpreted as including each individual unit of the listed elements, e.g., A, each subset of the listed elements, e.g., A and B, or the entire list of elements A, B, and C.

According to one embodiment of the present disclosure, the first measurement signal is a frequency-modulated continuous wave signal, FMCW signal. According to another embodiment of the present disclosure, the second measurement signal is a continuous wave signal with a constant frequency (CW signal).

According to a further embodiment of the present disclosure, the measurement signal generation and control circuit is configured to switch between the generation of the first measurement signal and the generation of the second measurement signal only when no level echo can be detected in the measurement with the first measurement signal or, alternatively, when the level echo cannot be clearly detected.

According to a further embodiment of the present disclosure, the measurement signal generation and control circuit is configured to switch periodically between generating the first measurement signal and generating the second measurement signal. Alternatively or additionally, it may be configured to switch between generating the two measurement signals in an event-driven manner.

According to an embodiment of the present disclosure, the measurement signal generation and control circuit is configured to measure the energy of the reflected second measurement signal and to determine that the antenna is immersed in the fill material when the measured energy is above a predetermined threshold value.

According to a further embodiment of the present disclosure, the level measuring device is configured to perform a calibration measurement by a user, in which the threshold value is determined by immersing the antenna in the fill material and performing the measurement signal attenuation measurement.

According to an aspect of the present disclosure, a method for determining a fill level of a fill material is provided, comprising the following steps: generating a first measurement signal for performing a signal propagation time measurement; transmitting the first measurement signal through an antenna toward a fill material surface and receiving the first measurement signal reflected at the fill material surface to calculate the fill level through the antenna; calculating the fill level; switching from generating the first measurement signal to generating the second measurement signal; generating the second measurement signal to perform a measurement signal attenuation measurement; and radiating the second measurement signal through the antenna and receiving the reflected second measurement signal through the antenna to determine whether or not the antenna is covered by the filling material.

According to a further aspect of the present disclosure, a program element is provided which, when executed on a measurement signal generation and control circuit of a level measuring device, instructs the level measuring device to perform the method steps described above and below.

Another aspect of the present disclosure relates to a computer-readable medium on which the program element described above is stored.

Further embodiments of the present disclosure are described below with reference to the figures. The illustrations in the figures are schematic and not to scale. Where the same reference numerals are used in the following description of the figures, they denote the same or similar elements.

### BRIEF DESCRIPTION OF THE FIGURES

FIG. 1 shows two echo curves of a signal propagation time measurement at different fill levels.

FIG. 2 shows containers and measurement curves at two different fill levels.

FIG. 3 shows a flowchart of a method according to an embodiment of the present disclosure.

### DETAILED DESCRIPTION OF EMBODIMENTS

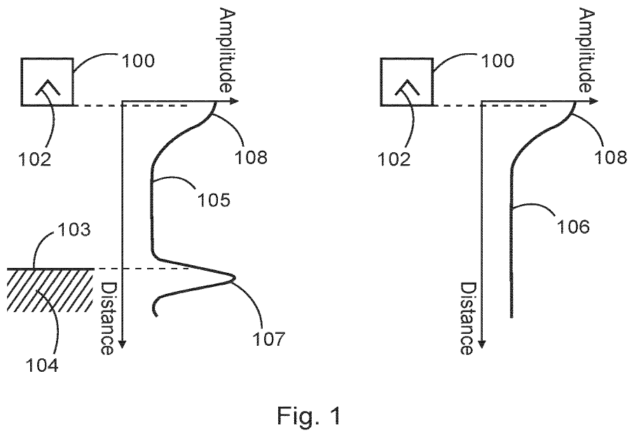

FIG. 1 shows two measurement curves 105, 106. Measurement curve 105 was recorded with a first measurement signal for performing a signal propagation time measurement, as was measurement curve 106.

In measurement curve 105, the surface 103 of the filling material 104 is at a significant distance from the antenna 102 of the level measuring device 100. In this measurement curve, the x-axis represents the distance between the filling material surface and the antenna 102, while the y-axis represents the amplitude of the reflected measurement signal. The level echo 107 is clearly visible here. The so-called antenna ringing 108 in the vicinity of the antenna 102 is also visible.

If the level echo 107 moves close to the antenna 102 as the level rises, the level echo 107 disappears in the antenna ringing 108 and can no longer be reliably detected.

The level measuring device 100, which is a radar sensor, can switch from FMCW measurement mode or pulse measurement mode (first measurement signal) to continuous wave radar measurement mode (second measurement signal) in order to measure the attenuation of the second measurement signal. The switchover can be triggered by time or by a control signal. This allows the flooding or immersion of the antenna in the filling material to be reliably detected. In particular, this can also be reliably detected immediately after switching on the level measuring device 100. This offers particular advantages for self-sufficient sensors that only measure at certain intervals. In particular, the level measuring device can be set up to record additional information about the installation situation in the container or at the measuring point.

The radar level measuring device records an echo curve. However, since this may not show a (clear) level echo under certain circumstances, for example when the container is empty, when there is significant foam formation or when the container is flooded, the sensor cannot distinguish whether the container is filled/flooded up to and including the radar antenna or not. By switching to the second measurement signal and measuring the reflected amplitude, the sensor can reliably detect whether the container/sensor is flooded.

Level radar measuring devices based on the pulse or FMCW principle, or other sensors that operate according to the ToF principle, such as ultrasonic sensors or laser sensors, often have a problem with sensitivity in the near range due to the coupling or decoupling of the measurement signal.

For radar level meters, this means that the level meter can measure the level with less accuracy or not at all in the near range. If the antenna 102 is completely submerged or if the level meter 100 is completely below the surface of the material (flooded), the level meter can no longer detect a signal. An echo curve always has a deflection in amplitude in the near range during coupling (antenna), known as antenna ringing. If the sensor/antenna is completely submerged, for example in the event of flooding, no echo signal can be detected on the echo curve. However, this does not affect the antenna ringing, which can be disadvantageous as it cannot be recognized or detected by the sensor as an error or an indication of flooding.

There can be many reasons why no level echo is visible in the right-hand measurement curve.

Only the antenna ringing can be seen on the right echo curve. This condition can occur for various reasons. Examples include:
The antenna and/or level meter are completely submerged in the filling material, for example water;
Foam on the surface of the liquid;
Level echoes outside the measuring range;
The container is empty and, due to the geometry of the container (e.g., sloping container bottom), the reflection signal from the bottom is reflected away from the level measuring device rather than toward it;
Liquids with low dielectric constants and processes with difficult process conditions (turbulent surfaces, gas entrapment, etc.);
Attenuation of the radar signal due to the gas atmosphere in the tank (ammonia, vinyl chloride, acetone, etc.);
Reflector below the sensor or manipulation of the measuring point (sensor measures into the sky).

To detect flooding or immersion of the antenna 102, the level meter 100 switches to a continuous wave signal. The term “continuous wave” is not 100% correct in physical terms, as a microwave signal with a constant frequency is only emitted for a short period of time. The level meter measures the reflected energy of the measurement signal. Similar to a microwave barrier, such as in the VEGA MIP measuring device. This allows it to detect whether the sensor/antenna is submerged or flooded.

It also allows a short area in front of the antenna to be effectively monitored. The antenna does not therefore have to be 100% submerged. If the level meter has no signal but only detects the antenna ringing, it can detect flooding by switching to continuous wave mode.

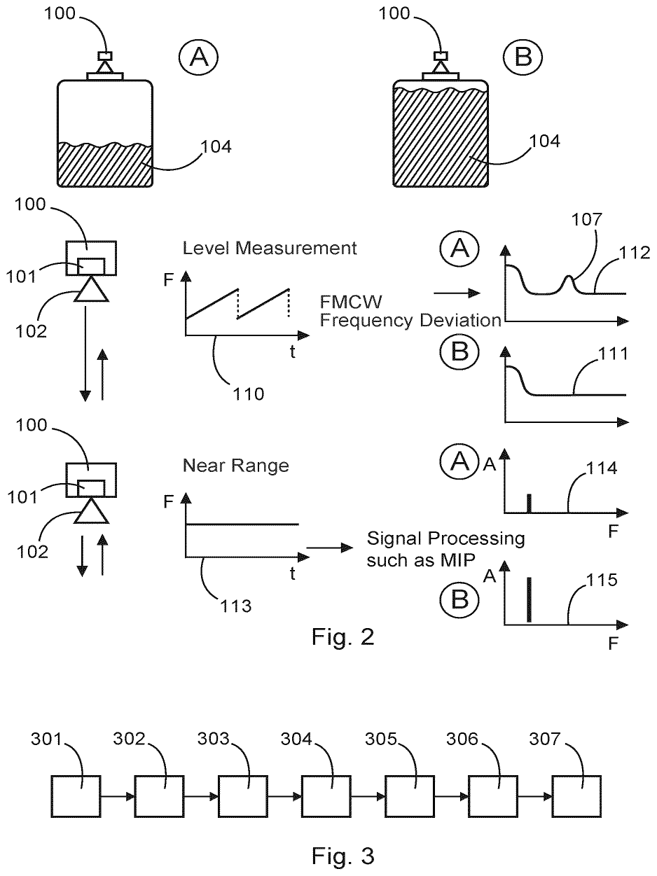

FIG. 2 shows a container A with a low fill level and a container B with a very high fill level, where the overflow situation can be seen. The level gauge 100 is mounted on the top outside of the container. In this embodiment, the container is a plastic container that is transparent to the radar signal.

The level radar gauge 100 has a measurement problem in the near range. In the near range, no fill level echo can be detected in the echo curve 111 during the transit time measurement 110 because the container is overfilled. In the echo curve 112, which was recorded in state A, i.e., at a lower fill level, a fill level echo 107 can clearly be detected.

If the level measuring device 100 now switches to the second operating mode, in which the second measuring signal is used (continuous wave signal), the reflected energy can be measured. An example of such a continuous wave signal is shown in measurement curve 113, with the time axis t and the frequency axis F. In situation A, the reflected energy is measured according to curve 114, i.e., a relatively low amplitude. In the overfill situation B, a significantly higher amplitude (see measurement curve 115) is measured.

This indicates overfilling, as the amplitude exceeds a predetermined threshold value.

According to an embodiment, the level measuring device can be preset at the factory for the amplitude values for evaluating the attenuation (continuous wave, from which threshold the sensor is flooded). According to one embodiment, the level measuring device recognizes this threshold itself and learns, since the threshold can vary depending on the installation situation.

FIG. 3 shows a flow chart of a method according to one embodiment. In step 301, a measurement signal is generated to perform a signal propagation time measurement and, in step 302, it is emitted in the direction of the fill surface, where it is reflected and the reflected measurement signal is received again by the antenna. In step 303, the fill level is calculated from this, in particular by evaluating an echo curve. If it is now determined that the fill level echo cannot be identified with sufficient accuracy or cannot be found at all, the fill level measuring device switches to the generation of a second measurement signal, which is, for example, a continuous wave signal (see step 304). In step 305, this measurement signal is then generated and emitted. In step 306, the reflected second measurement signal is received and the amplitude of the received measurement signal is evaluated to determine whether the antenna is covered by the filling material or not. In step 307, the measuring device switches back to the first measurement mode, in which the first measurement signal is used for level measurement.

1.-10. (canceled)

11. A level measuring device configured for process automation in industrial or private environments, comprising:
a measurement signal generation and control circuit configured to generate a first measurement signal for performing a signal propagation time measurement and to generate a second measurement signal for performing a measurement signal attenuation measurement; and
an antenna configured to radiate the first and the second measurement signals in a direction of a fill level surface and to receive the first measurement signal reflected at the fill level surface or the second measurement signal reflected at the fill level surface for calculating the fill level,
wherein the measurement signal generation and control circuit is further configured to switch between generating the first measurement signal and generating the second measurement signal.

12. The level measuring device according to claim 11, wherein the first measurement signal is a frequency-modulated continuous wave (FMCW) signal.

13. The level measuring device according to claim 11, wherein the second measurement signal is a continuous wave signal with a constant frequency.

14. The level measuring device according to claim 11, wherein the measurement signal generation and control circuit is further configured to switch between generating the first measurement signal and generating the second measurement signal when no level echo can be detected in the measurement with the first measurement signal.

15. The level measuring device according to claim 11, wherein the measurement signal generation and control circuit is further configured to switch periodically between generating the first measurement signal and generating the second measurement signal.

16. The level measuring device according to claim 11, wherein the measurement signal generation and control circuit is further configured to measure the energy of the reflected second measurement signal and to determine that the antenna is immersed in the filling material when the measured energy is above a predetermined threshold value.

17. The level measuring device according to claim 16, wherein the level measuring device is configured to perform a calibration measurement by a user, in which the predetermined threshold value is determined by immersing the antenna in the filling material and performing the measurement signal attenuation measurement.

18. A method for determining a fill level, comprising the steps of:
generating a first measurement signal for performing a signal propagation time measurement;
emitting the first measurement signal through an antenna toward a fill material surface and receiving the first measurement signal reflected at the fill material surface to calculate the fill level through the antenna;
calculating the fill level;
switching from generating the first measurement signal to generating a second measurement signal;
generating the second measurement signal for performing a measurement signal attenuation measurement; and
transmitting the second measurement signal through the antenna and receiving the reflected second measurement signal through the antenna to determine whether or not the antenna is covered by the filling material.

19. A nontransitory computer-readable medium having stored thereon instructions that, when executed on a measurement signal generation and control circuit of a level measuring device, instructs the level measuring device to perform the following steps:
generating a first measurement signal for performing a signal propagation time measurement;
transmitting the first measurement signal through an antenna toward a fill material surface and receiving the first measurement signal reflected at the fill material surface to calculate the fill level through the antenna;
calculating the fill level;
switching from generating the first measurement signal to generating a second measurement signal;
generating the second measurement signal to perform a measurement signal attenuation measurement; and
emitting the second measurement signal through the antenna and receiving the reflected second measurement signal through the antenna to determine whether or not the antenna is covered by the filling material.
